(19) United States
(12) Patent Application Publication
(10) Pub. No.: US 2017/0214127 A1
(43) Pub. Date: Jul. 27, 2017

(54) ANTENNA DEPLOYMENT FOR MEDICAL IMPLANTS

(71) Applicant: QUALCOMM Incorporated, San Diego, CA (US)

(72) Inventors: Adam Edward NEWHAM, Poway, CA (US); William Henry VON NOVAK, III, San Diego, CA (US); Ravindra SHENOY, Dublin, CA (US); Rashid Ahmed Akbar ATTAR, San Diego, CA (US); Kenneth David EASTON, San Diego, CA (US)

(21) Appl. No.: 15/253,371

(22) Filed: Aug. 31, 2016

Related U.S. Application Data
(60) Provisional application No. 62/287,360, filed on Jan. 26, 2016.

(51) Int. Cl. H01Q 1/27; H01Q 1/40; H01Q 1/36; H04B 5/00; H01Q 7/00

(52) U.S. Cl. CPC H01Q 1/273; H04B 5/0037; H01Q 7/00; H01Q 1/36; H01Q 1/40

(57) ABSTRACT

A biomedical system includes: a medical implant capsule including an outer body, an electric device retained by the outer body, and a power input coupled to the electric device, the medical implant capsule having a length, along an axis, and a width transverse to the axis; and an antenna coupled to the power input and configured to: receive power wirelessly and to deliver the power to the power input; wrap around the medical implant capsule, in a transit state, transverse to the length of the medical implant capsule for a distance greater than the width of the medical implant capsule; and expand to a deployed state, at least part of the antenna being further from the axis in the deployed state than in the transit state.

### CROSS-REFERENCE TO RELATED APPLICATIONS

This application claims the benefit of U.S. Provisional Application No. 62/287,360, filed Jan. 26, 2016, entitled “ANTENNA DEPLOYMENT FOR MEDICAL IMPLANTS,” the entire contents of which is hereby incorporated herein by reference.

### TECHNICAL FIELD

The disclosure relates generally to wireless power delivery to electronic devices, and in particular to selective power transmitting element use for wireless power transfer, e.g., to implanted electronic devices.

### BACKGROUND

An increasing number and variety of electronic devices are powered via rechargeable batteries. Such devices include mobile phones, portable music players, laptop computers, tablet computers, computer peripheral devices, communication devices (e.g., BLUETOOTH devices), digital cameras, hearing aids, and the like. While battery technology has improved, battery-powered electronic devices increasingly require and consume greater amounts of power. As such, these devices frequently require recharging. Rechargeable devices are often charged via wired connections that require cables or other similar connectors that are physically connected to a power supply. Cables and similar connectors may sometimes be inconvenient or cumbersome and have other drawbacks. Wireless power charging systems may allow users to charge and/or power electronic devices without physical, electro-mechanical connections, thus simplifying the use of the electronic device.

Further, an increasing number of electronic devices are being implanted in patients. For example, implantable electronic devices include pace makers, cochlear implants, retinal implants, and biometric monitoring systems for monitoring a variety of parameters such as blood characteristics. Wired recharging of these devices is often undesirable.

### SUMMARY

An example of a biomedical system includes: a medical implant capsule including an outer body that is biologically compatible, an electric device retained by the outer body, and a power input coupled to the electric device, the medical implant capsule having a length, along an axis, and a width transverse to the axis; and an antenna coupled to the power input and configured to: receive power wirelessly and to deliver the power to the power input; wrap around the medical implant capsule, in a transit state, transverse to the length of the medical implant capsule for a distance greater than the width of the medical implant capsule; and expand to a deployed state, at least part of the antenna being further from the axis in the deployed state than in the transit state.

Another example of a biomedical system includes: a sleeve defining a chamber having a chamber width that is transverse to a chamber length that is parallel to an axis of the sleeve, the chamber length being longer than the chamber width; and an antenna with an antenna length and an antenna width, the antenna length and the antenna width each being larger than the chamber width, the antenna including a flexible coil and being configured to: receive power wirelessly; bend about the length of the antenna to be received by the chamber in a transit state; and expand to a deployed state outside of the sleeve such that the flexible coil antenna is incapable of being received by the sleeve while in the deployed state.

An example of a method includes: inserting a medical implant through a tube into a patient, the medical implant including a sleeve, a capsule disposed inside the sleeve, and an antenna electrically coupled to an electrical device of the capsule; removing the medical implant from the tube; extracting the capsule and the antenna from the sleeve; and positioning the antenna of the medical implant into a deployed state in which the antenna is incapable of being received within the tube.

Another example of a biomedical system includes: a sleeve defining a cylindrical chamber having a chamber diameter that is transverse to a chamber length that is parallel to an axis of the sleeve, the chamber length being longer than the chamber diameter; a medical implant capsule including: a cylindrical outer body that is biologically compatible and of a capsule length; an electric device retained by the cylindrical outer body; and a power input electrically coupled to the electric device; and an antenna coupled to the power input and configured to: receive power wirelessly and to deliver received power to the power input; wrap around the cylindrical outer body of the medical implant capsule transverse to the capsule length for a distance greater than the chamber width; and expand from a transit state to a deployed state, the antenna being biased toward the deployed state.

The following detailed description and accompanying drawings provide a better understanding of the nature and advantages of the present disclosure.

### BRIEF DESCRIPTION OF THE DRAWINGS

Drawing elements that are common among the following figures may be identified using the same reference numerals.

With respect to the discussion to follow and in particular to the drawings, the particulars shown represent examples for purposes of illustrative discussion, and are presented in the cause of providing a description of principles and conceptual aspects of the disclosure. In this regard, no attempt is made to show implementation details beyond what is needed for a fundamental understanding of the disclosure. The discussion to follow, in conjunction with the drawings, makes apparent to those of skill in the art how embodiments in accordance with the disclosure may be practiced.

FIG. 1 is a simplified view of a minimally-invasive surgery on a patient.

FIG. 2 is a functional block diagram of an example of a wireless power transfer system.

FIG. 3 is a functional block diagram of another example of a wireless power transfer system.

FIG. 4 is a schematic diagram of an example of a portion of transmit circuitry or receive circuitry of the system shown in FIG. 3.

FIG. 5 is a side view of an implant with a capsule and an antenna partially received by a sleeve, and the antenna in a transit state.

FIG. 6 is a perspective exploded view of the sleeve, and the antenna and a capsule shown in FIG. 5.

FIG. 7 is an end view of the capsule and the antenna shown in FIG. 6.

FIG. 8 is a side view of the implant shown in FIG. 5 with the antenna in a deployed state.

FIG. 9 is a perspective view of another implant with a capsule and an antenna in a deployed state.

FIG. 10 is a simplified side view of a capsule and two antennas of an implant, with both of the antennas in deployed states.

FIG. 11 is a block flow diagram of a method of positioning an antenna inside a patient.

FIG. 12 is a block diagram of another example of an implant.

FIGS. 13-14 are end views of a capsule and further examples of antennas wrapped around the capsule.

### DETAILED DESCRIPTION

Wireless power transfer may refer to transferring any form of energy associated with electric fields, magnetic fields, electromagnetic fields, or otherwise from a transmitter to a receiver without physical electrical conductors attached to and connecting the transmitter to the receiver to deliver the power (e.g., power may be transferred through free space). The power output into a wireless field (e.g., a magnetic field or an electromagnetic field) may be received, captured by, or coupled to by a power receiving element to achieve power transfer. The transmitter transfers power to the receiver through a wireless coupling of the transmitter and receiver.

Techniques are discussed for providing wireless power to an implant and in particular for providing sufficient power to the implant despite energy loss between a power source and the implant. For example, an implant includes an implant capsule and a collapsible and expandable antenna that is coupled to the implant capsule. The implant capsule includes electronic components for performing one or more desired functions. The antenna is collapsible to fit within a surgical instrument for delivery of the implant inside of a patient, and is expandable to a deployed state. In the deployed state, the antenna would receive enough energy to power the implant capsule to meet the link budget, i.e., enough energy is received via the antenna (after any losses incurred in the radio path) such that, after conversion from RF to DC, the implant is able to enter a powered-on state.

Items and/or techniques described herein may provide one or more of the following capabilities, as well as other capabilities not mentioned. Sufficient power may be delivered to an implant located inside a patient and inserted into the patient using a surgical tube. Sufficient power may be delivered deep, e.g., six inches or more, into a patient to an electronic medical implant to power the implant. An expandable wireless power receiving antenna and/or an expandable communications antenna may be provided for a medical implant inserted into a patient through a surgical tube where each antenna in a deployed state is larger, at least on one dimension, than a cross-sectional dimension of the surgical tube. Other capabilities may be provided and not every implementation according to the disclosure must provide any, let alone all, of the capabilities discussed. Further, it may be possible for an effect noted above to be achieved by means other than that noted, and a noted item/technique may not necessarily yield the noted effect.

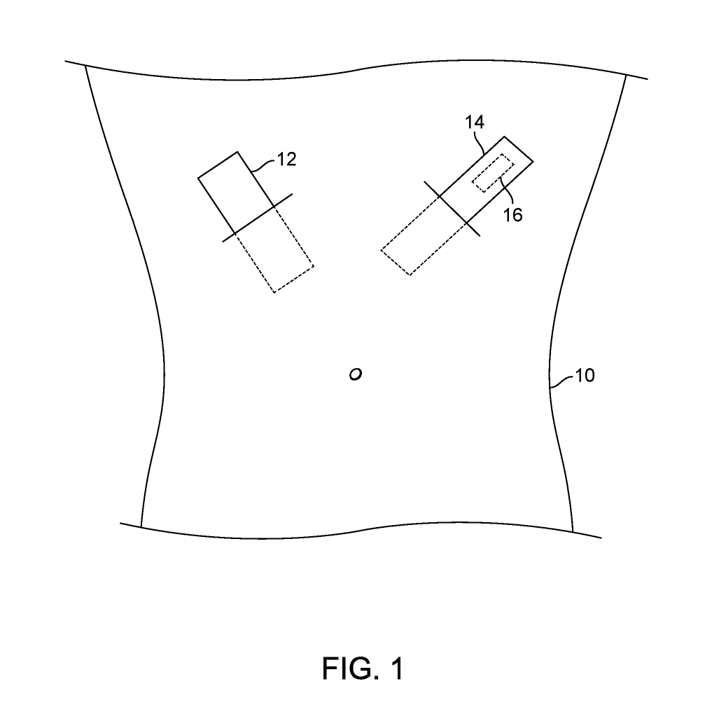

Referring to FIG. 1, a patient 10 has two surgical tools 12, 14 inserted into the patient's abdomen during a minimally-invasive surgery. A minimally-invasive surgery is one that is less invasive than with techniques of years past, e.g., where a large incision was made to allow a surgeon to view the entire operating area and to insert all surgical tools used during the surgery. A minimally-invasive surgery is not, however, necessarily the least-invasive surgery possible. The surgical tool 12 may be or include any of a variety of tools such as a trocar, a camera, scissors, etc. The surgical tool 14 is a tube that provides a mechanism for access into the patient 10, e.g., for delivery of other surgical tools or, in this example, an implant 16. The implant 16 may be any of a variety of implants such as, but not limited to, a pace maker or a biometric monitoring system, e.g., for monitoring blood characteristics. The implant 16 includes an electronic operation portion, e.g., for monitoring characteristics, for processing monitored information, for providing an electronic signal, and/or for one or more other functions. The implant 16 also includes a wireless power reception device for receiving power wirelessly from a wireless power transmission device and for delivering the power to the electronic operation portion.

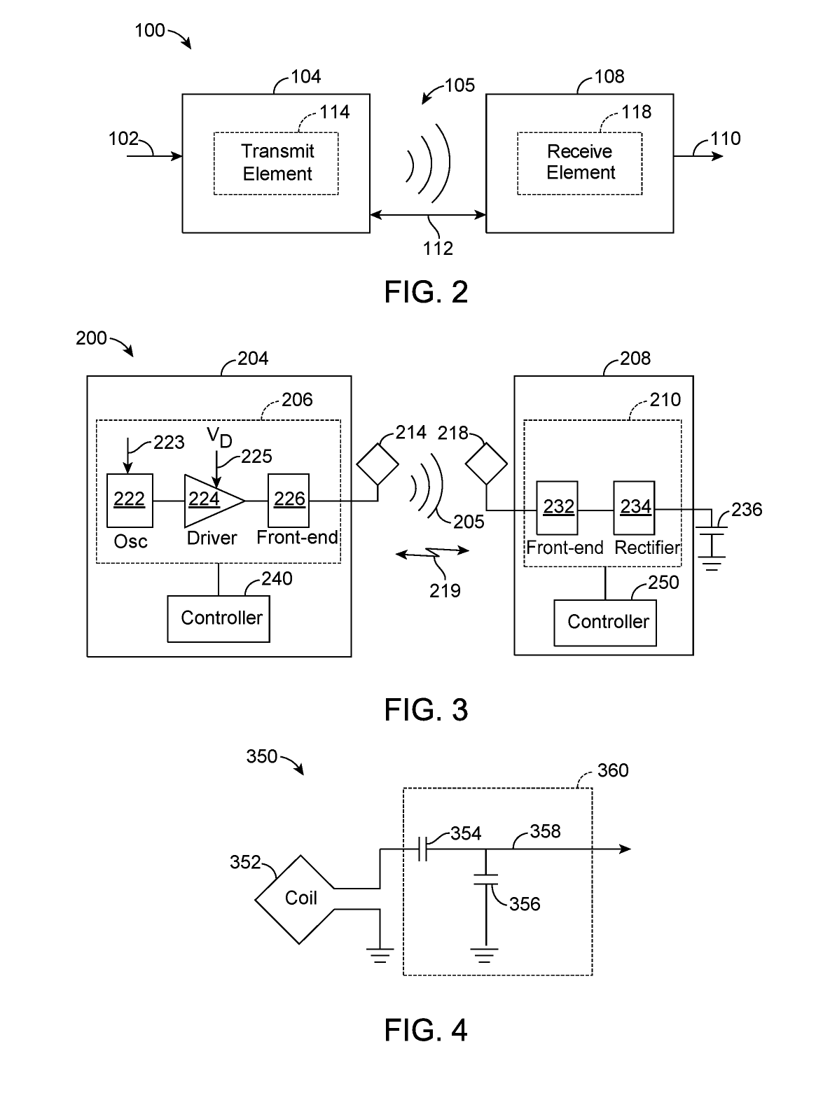

FIG. 2 is a functional block diagram of an example of a wireless power transfer system 100. Input power 102 may be provided to a transmitter 104 from a power source (not shown in this figure) to generate a wireless (e.g., magnetic or electromagnetic) field 105 for performing energy transfer. A receiver 108 may couple to the wireless field 105 and generate output power 110 for storing or consumption by a device (not shown in this figure) that is coupled to receive the output power 110. The transmitter 104 and the receiver 108 are separated by a non-zero distance 112. The transmitter 104 includes a power transmitting element 114 configured to transmit/couple energy to the receiver 108. The receiver 108 includes a power receiving element 118 configured to receive or capture/couple energy transmitted from the transmitter 104.

The transmitter 104 and the receiver 108 may be configured according to a mutual resonant relationship. When the resonant frequency of the receiver 108 and the resonant frequency of the transmitter 104 are substantially the same, transmission losses between the transmitter 104 and the receiver 108 are reduced compared to the resonant frequencies not being substantially the same. As such, wireless power transfer may be provided over larger distances when the resonant frequencies are substantially the same. Resonant inductive coupling techniques allow for improved efficiency and power transfer over various distances and with a variety of inductive power transmitting and receiving element configurations.

The wireless field 105 may correspond to the near field of the transmitter 104. The near field corresponds to a region in which there are strong reactive fields resulting from currents and charges in the power transmitting element 114 that do not significantly radiate power away from the power transmitting element 114. The near field may correspond to a region that up to about one wavelength, of the power transmitting element 114. Efficient energy transfer may occur by coupling a large portion of the energy in the wireless field 105 to the power receiving element 118 rather than propagating most of the energy in an electromagnetic wave to the far field.

The transmitter 104 may output a time-varying magnetic (or electromagnetic) field with a frequency corresponding to the resonant frequency of the power transmitting element 114. When the receiver 108 is within the wireless field 105, the time-varying magnetic (or electromagnetic) field may induce a current in the power receiving element 118. As described above, with the power receiving element 118 configured as a resonant circuit to resonate at the frequency of the power transmitting element 114, energy may be efficiently transferred. An alternating current (AC) signal induced in the power receiving element 118 may be rectified to produce a direct current (DC) signal that may be provided to charge an energy storage device (e.g., a battery) or to power a load.

FIG. 3 is a functional block diagram of an example of a wireless power transfer system 200. The system 200 includes a transmitter 204 and a receiver 208. The transmitter 204 (also referred to herein as power transmitting unit, PTU) is configured to provide power to a power transmitting element 214 that is configured to transmit power wirelessly to a power receiving element 218 that is configured to receive power from the power transmitting element 214 and to provide power to the receiver 208. Despite their names, the power transmitting element 214 and the power transmitting element 218, being passive elements, may transmit and receive power and communications.

The transmitter 204 includes the power transmitting element 214, transmit circuitry 206 that includes an oscillator 222, a driver circuit 224, and a front-end circuit 226. The power transmitting element 214 is shown outside the transmitter 204 to facilitate illustration of wireless power transfer using the power transmitting element 218. The oscillator 222 may be configured to generate an oscillator signal at a desired frequency that may adjust in response to a frequency control signal 223. The oscillator 222 may provide the oscillator signal to the driver circuit 224. The driver circuit 224 may be configured to drive the power transmitting element 214 at, for example, a resonant frequency of the power transmitting element 214 based on an input voltage signal (VD) 225. The driver circuit 224 may be a switching amplifier configured to receive a square wave from the oscillator 222 and output a sine wave.

The front-end circuit 226 may include a filter circuit configured to filter out harmonics or other unwanted frequencies. The front-end circuit 226 may include a matching circuit configured to match the impedance of the transmitter 204 to the impedance of the power transmitting element 214. As will be explained in more detail below, the front-end circuit 226 may include a tuning circuit to create a resonant circuit with the power transmitting element 214. As a result of driving the power transmitting element 214, the power transmitting element 214 may generate a wireless field 205 to wirelessly output power at a level sufficient for charging a battery 236, or powering a load.

The transmitter 204 further includes a controller 240 operably coupled to the transmit circuitry 206 and configured to control one or more aspects of the transmit circuitry 206, or accomplish other operations relevant to managing the transfer of power. The controller 240 may be a micro-controller or a processor. The controller 240 may be implemented as an application-specific integrated circuit (ASIC). The controller 240 may be operably connected, directly or indirectly, to each component of the transmit circuitry 206. The controller 240 may be further configured to receive information from each of the components of the transmit circuitry 206 and perform calculations based on the received information. The controller 240 may be configured to generate control signals (e.g., signal 223) for each of the components that may adjust the operation of that component. As such, the controller 240 may be configured to adjust or manage the power transfer based on a result of the operations performed by the controller 240. The transmitter 204 may further include a memory (not shown) configured to store data, for example, such as instructions for causing the controller 240 to perform particular functions, such as those related to management of wireless power transfer.

The receiver 208 (also referred to herein as power receiving unit, PRU) includes the power receiving element 218, and receive circuitry 210 that includes a front-end circuit 232 and a rectifier circuit 234. The power receiving element 218 is shown outside the receiver 208 to facilitate illustration of wireless power transfer using the power receiving element 218. The front-end circuit 232 may include matching circuitry configured to match the impedance of the receive circuitry 210 to the impedance of the power receiving element 218. As will be explained below, the front-end circuit 232 may further include a tuning circuit to create a resonant circuit with the power receiving element 218. The rectifier circuit 234 may generate a DC power output from an AC power input to charge the battery 236, as shown in FIG. 3. The receiver 208 and the transmitter 204 may additionally communicate on a separate communication channel 219 (e.g., BLUETOOTH, ZIGBEE, cellular, etc.). The receiver 208 and the transmitter 204 may alternatively communicate via in-band signaling using characteristics of the wireless field 205.

The receiver 208 may be configured to determine whether an amount of power transmitted by the transmitter 204 and received by the receiver 208 is appropriate for charging the battery 236. The transmitter 204 may be configured to generate a predominantly non-radiative field with a direct field coupling coefficient (k) for providing energy transfer. The receiver 208 may directly couple to the wireless field 205 and may generate an output power for storing or consumption by a battery (or load) 236 coupled to the output or receive circuitry 210.

The receiver 208 further includes a controller 250 that may be configured similarly to the transmit controller 240 as described above for managing one or more aspects of the wireless power receiver 208. The receiver 208 may further include a memory (not shown) configured to store data, for example, such as instructions for causing the controller 250 to perform particular functions, such as those related to management of wireless power transfer.

As discussed above, transmitter 204 and receiver 208 may be separated by a distance and may be configured according to a mutual resonant relationship to try to minimize transmission losses between the transmitter 204 and the receiver 208.

FIG. 4 is a schematic diagram of an example of a portion of the transmit circuitry 206 or the receive circuitry 210 of FIG. 3. While a coil, and thus an inductive system, is shown in FIG. 4, other types of systems, such as capacitive systems for coupling power, may be used, with the coil replaced with an appropriate power transfer (e.g., transmit and/or receive) element. As illustrated in FIG. 4, transmit or receive circuitry 350 includes a power transmitting or receiving element 352 and a tuning circuit 360. The power transmitting or receiving element 352 may also be referred to or be configured as an antenna such as a “loop” antenna. The term “antenna” generally refers to a component that may wirelessly output energy for reception by another antenna and that may receive wireless energy from another antenna. The power transmitting or receiving element 352 may also be referred to herein or be configured as a “magnetic” antenna, such as an induction coil (as shown), a resonator, or a portion of a resonator. The power transmitting or receiving element 352 may also be referred to as a coil or resonator of a type that is configured to wirelessly output or receive power. As used herein, the power transmitting or receiving element 352 is an example of a “power transfer component” of a type that is configured to wirelessly output and/or receive power. The power transmitting or receiving element 352 may include an air core or a physical core such as a ferrite core (not shown).

When the power transmitting or receiving element 352 is configured as a resonant circuit or resonator with tuning circuit 360, the resonant frequency of the power transmitting or receiving element 352 may be based on the inductance and capacitance. Inductance may be simply the inductance created by a coil and/or other inductor forming the power transmitting or receiving element 352. Capacitance (e.g., a capacitor) may be provided by the tuning circuit 360 to create a resonant structure at a desired resonant frequency. As a non-limiting example, the tuning circuit 360 may comprise a capacitor 354 and a capacitor 356, which may be added to the transmit or receive circuitry 350 to create a resonant circuit.

The tuning circuit 360 may include other components to form a resonant circuit with the power transmitting or receiving element 352. As another non-limiting example, the tuning circuit 360 may include a capacitor (not shown) placed in parallel between the two terminals of the circuitry 350. Still other designs are possible. For example, the tuning circuit in the front-end circuit 226 may have the same design (e.g., 360) as the tuning circuit in the front-end circuit 232. Alternatively, the front-end circuit 226 may use a tuning circuit design different than in the front-end circuit 232.

For power transmitting elements, the signal 358, with a frequency that substantially corresponds to the resonant frequency of the power transmitting or receiving element 352, may be an input to the power transmitting or receiving element 352. For power receiving elements, the signal 358, with a frequency that substantially corresponds to the resonant frequency of the power transmitting or receiving element 352, may be an output from the power transmitting or receiving element 352. Although aspects disclosed herein may be generally directed to resonant wireless power transfer, persons of ordinary skill will appreciate that aspects disclosed herein may be used in non-resonant implementations for wireless power transfer.

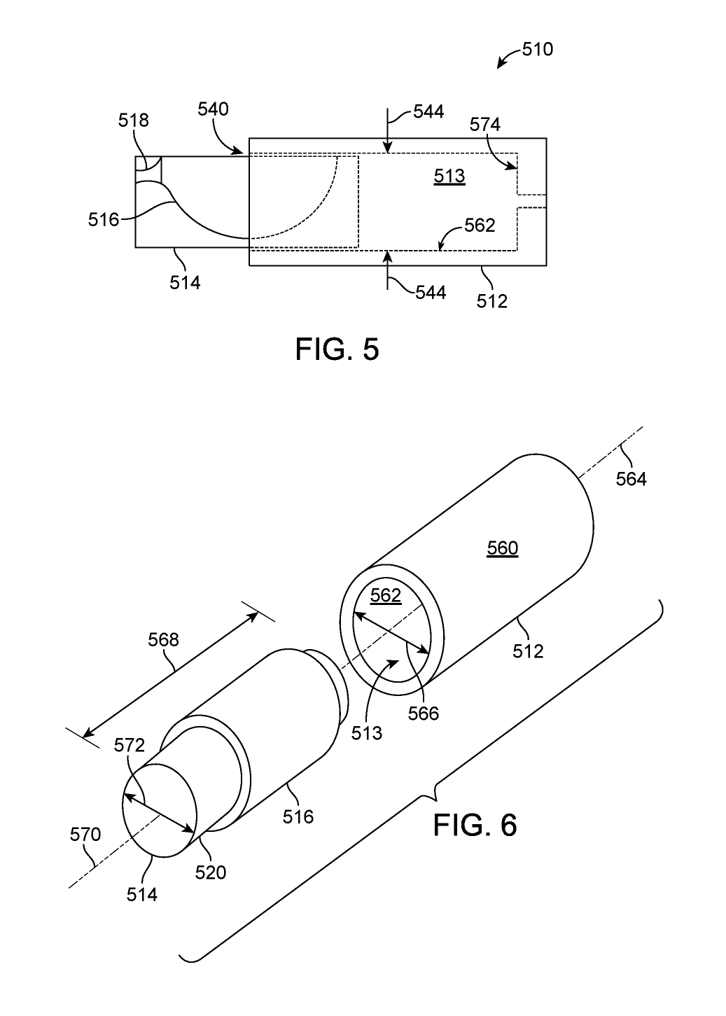

Referring to FIGS. 5-8, with further reference to FIG. 1, an example of an implant 510 (e.g., an example of the implant 16 shown in FIG. 1) includes a sleeve 512, a capsule 514, an antenna 516, and an electrical connector 518. The implant 510 is configured to allow the capsule 514 and the antenna 516 to be delivered to a desired location within a patient and to be put in the patient at the desired location (e.g., attached to the patient, disposed within a vessel of the patient, etc.). The implant 510 is configured such that the antenna 516 is movable from a transit state, e.g., as shown in FIGS. 5-7, to a deployed state, e.g., as shown in FIG. 8. The implant 510 may be an example of a biomedical system, with the capsule 514 being a medical implant capsule. In this example, the sleeve 512 is not mechanically attached to the capsule 514 such that the capsule 514, the connector 518, and the antenna 516 may be separated from the sleeve 512, e.g., such that the sleeve may be removed from a patient and the capsule 514, the antenna 516, and the connector 518 left implanted in the patient. The sleeve 512 however may be temporarily outside of the delivery tool and in direct contact with the patient, and is thus part of the implant 510. Further, the sleeve 512 could be mechanically attached (e.g., tethered) to the capsule 514 such that the sleeve 512 remains with the capsule 514, the antenna 516, and the connector 518 inside the patient.

The implant 510 is a biomedical system, as the implant 510 is configured to be used in conjunction with a biological body such as the patient 10, and numerous other configurations of biomedical systems may be used. For example, an implant may include the capsule 514 and the antenna 516, but not the sleeve 512. As another example, an implant may include the sleeve 512 and the antenna 516, but not the capsule 514. With such an implant, the antenna 516 may be delivered, e.g., to a region of the patient 10 and connected with a desired electrical device such as the capsule 514.

The sleeve 512 is configured to be received by a surgical tool for delivering the implant 510 to a desired location within the patient 10. For example, a perimeter (of an outer surface 560) of the sleeve 512 is sized and shaped to fit within the surgical tool 14, with the surgical tool 14 being a tube. The tube may have any of a variety of cross-sectional shapes, e.g., circular, rectangular, hexagonal, octagonal, etc. Thus, the perimeter of the sleeve 512 may be circular, rectangular, etc. to fit within the surgical tool 14. The shape of the perimeter of the sleeve 512 need not match the cross-sectional shape of the surgical tool 14. Further, the sleeve 512 is preferably made of a biologically-compatible material (i.e., a material not known to cause negative effects to a patient's body) and more preferably a biologically-inert material to facilitate delivery of the implant 510 without negative effects. For example, the sleeve 512 may be made of a ceramic, titanium, and/or other appropriate material(s).

The sleeve 512 is further configured to receive and retain the capsule 514 and the antenna 516, and to allow removal of the capsule 514 and the antenna 516. The sleeve 512 can act as a container that can retain the antenna 516 in a transit state, here conforming to an exterior shape of the capsule 514, for delivery to a desired location in the patient 10 via the surgical tool 14. The sleeve 512 is a tubular container with an inner surface 562 (FIG. 6) defining a chamber 513 configured to receive the capsule 514 and the antenna 516 (in the transit state). The sleeve 512 being a tube does not limit a cross-sectional shape of the outer surface 560 or the inner surface 562 of the sleeve 512 to being circular, as the sleeve 512 may have numerous other outer and/or inner shapes, e.g., rectangular, octagonal, etc. Further, the cross-sectional shape of the inner surface 562 need not match the cross-sectional shape of the outer surface 560. Further, the inner surface 562 may provide an end wall 574 for the chamber 513 to inhibit or prevent the capsule 514 from exiting the sleeve 512 from the end with the end wall 574. Further, the sleeve 512 has a length along, or parallel to, an axis 564 that is greater than a width 566 (here a diameter) of the chamber 513 provided by the sleeve 512.

The capsule 514 includes an outer body 520 (FIGS. 6, 8), an electric device 522, and a power input 524. The outer body 520 is preferably made of a biologically-compatible material, and more preferably of a biologically-inert material. The electric device 522 includes one or more electrically-powered components configured to perform one or more desired functions or operations. For example, the electric device 522 may be configured to monitor blood characteristics such as oxygen content. The electric device may also include the receive circuitry 210 and the controller 350 (FIG. 3). The electric device 522 is electrically coupled to the power input 524 that is electrically coupled to the electrical connector 518 that is electrically connected to the antenna 516. The outer body 520 has a length 568 along, or parallel to, an axis 570 that is greater than a width 572 (here a diameter) of the outer body 520 of the capsule 514 transverse to the axis 570.

The antenna 516 includes a conductive member 530 and a housing member 532, here a housing sheet. For example, the conductive member 530 may be flexible, or may include rigid conductive portions that are movably (e.g., pivotably) connected to each other, or a combination of these. In the example shown in FIG. 8, the conductive member 530 is a flexible conductive member that forms a circular spiral coil, but other configurations may be used, e.g., a differently-shaped spiral coil, multiple conductive plates, etc. The conductive member 530 is configured to receive power wirelessly (e.g., through inductive coupling) from a power source, e.g., with the antenna 516 being an example of the antenna 218 shown in FIG. 3, and to deliver the power to the power input 524, the antenna 516 being electrically coupled to the power input 524. The housing member 532 is preferably made of a biologically-compatible material and preferably encapsulated the conductive member 530 (the conductive member 530 is disposed inside the housing member 532 and isolated from contact with an entity other than the housing member 532). The electrical connector 518 may include electrically-conductive elements embedded in the housing member 532 as well.

The antenna 516 may have any of a variety of shapes. As shown in FIG. 8, the antenna 516 has a roughly circular, planar shape. This is an example only as other shapes, such as a rectangular shape, or another shape, may be used. The antenna 516 as shown is planar in that, despite having a non-zero thickness, the housing member 532 is a thin material that is configured to lie flat. The antenna 516 preferably has a length parallel to the axis 570 and a width that are both larger than the width 566 of the chamber 513.

The antenna 516 is collapsible and expandable between the transit state shown in FIGS. 5-7 and the deployed state shown in FIG. 8. The position (e.g., shape) of the antenna 516 in the transit state may be very different from the positions of the antenna 516 in the deployed state. The housing member 532 may be flexible to allow the antenna 516 to move between the transit state and the deployed state. In the transit state, the antenna 516 may substantially conform to the outside surface of the capsule 514, e.g., being wrapped around the capsule 514. The antenna 516 may not exactly conform to the shape of the capsule 514 as there may be gaps between the capsule 514 and the antenna 516, especially if the antenna includes one or more rigid components. For the transit state, the antenna 516 is configured to bend to wrap around the capsule 514. The antenna 516 is configured to be bent into a tube, e.g., with an interior shape that is similar to a shape of an exterior surface of the outer body 520. The antenna 516 is configured to bend transverse to a length of the antenna 516, with the length of the antenna being parallel to the axis 570 of the capsule 514. In particular, the antenna 516 is configured to wrap around an outer surface of the outer body 520 transverse to the length 568 of the outer body 520 for a distance 580 greater than the width 572 (here the diameter) of the outer body 520. The antenna 516 is preferably not folded, e.g., back on itself, as this may produce undesired stress on the antenna 516. To expand to the deployed state, the antenna 516 (or the antenna 630, or other antenna configuration) is configured to unwrap from the capsule 514, e.g., spreading out to a planar position extending flatly the full width of the antenna 516.

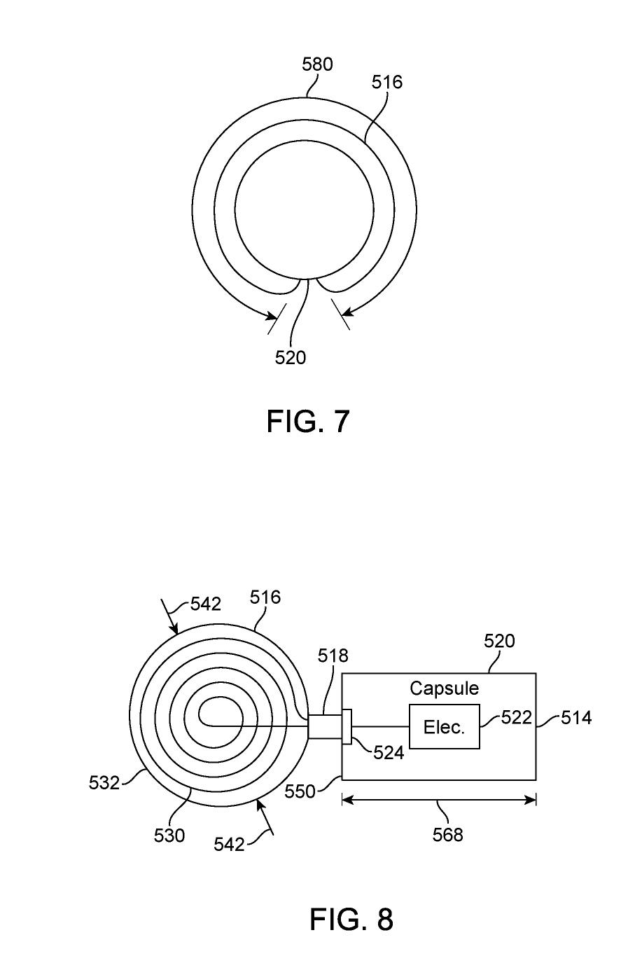

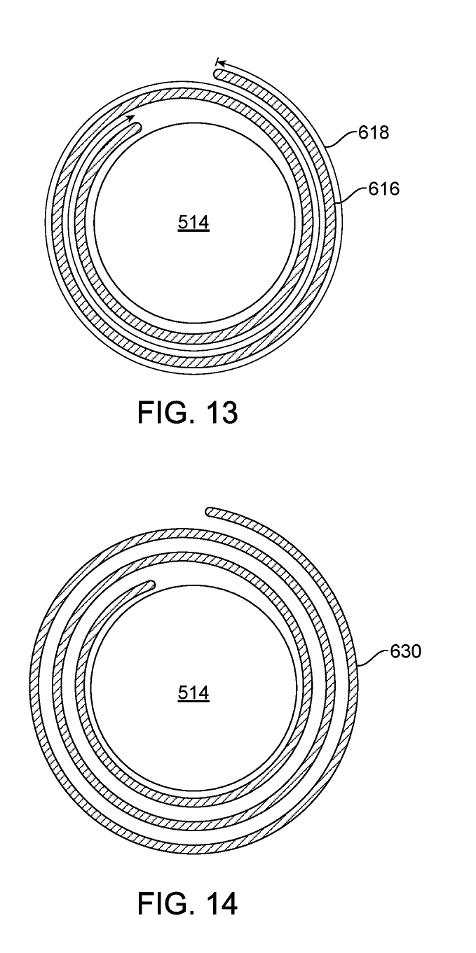

In the transit state, the antenna 516 may be wrapped less than all the way around a circumference of the capsule 514, all the way around the circumference of the capsule 514, or more than all the way around the circumference of the capsule 514 (and thus overlapping itself). As shown in FIG. 7, the antenna 516 may wrap around the capsule 514 such that the distance 580 is approximately equal to a perimeter (here a circumference) of the capsule 514 transverse to the axis 570. For example, the distance 580 may be greater than 80%, or greater than 90%, or greater than 95% of the perimeter of the capsule 514. Alternatively, an antenna may wrap around the capsule 514 for a distance that is greater than the perimeter of the capsule 514 transverse to the axis 570. For example, referring to FIG. 13, an antenna 616 (shown in cross-hatch for clarity) with a similar coil configuration as the antenna 516, but with a bigger expanse (width in the deployed state), wraps around the capsule 514 transverse to the axis 570 for a distance 618 that is greater than the perimeter of the capsule 514, indeed greater than 150% of the perimeter of the capsule 514, here approximately twice the perimeter of the capsule 514. The antenna 616, like the antenna 516, wraps around the capsule 514 symmetrically. Other configurations of antennas may wrap around the capsule 514 even more. Referring also to FIG. 14, an antenna 630 (shown in cross-hatch for clarity) wraps around the capsule 514 asymmetrically in a spiral fashion. The antenna 630 may be configured differently than the antenna 516, e.g., the antenna 630 may be a planar coil antenna, but fed off-center, i.e., with the electrical connector 518 not connected to a middle of an expanse of the antenna 630. The antenna 630, as shown, wraps around the capsule 514 multiple times, here for a distance of about 300% of the perimeter of the capsule 514, although greater or lesser amounts of wrapping (antenna widths) may be used. Still other configurations of antennas may be used.

The antenna is configured to be disposed, in the transit state, between the capsule 514 and the sleeve 512 with the capsule 514 and the antenna 516 received by the sleeve 512, that is, within the chamber 513. The antenna 516 is configured to be received by the sleeve 512 while the antenna 516 is in the transit state, and to be incapable of being received by the sleeve 512, and preferably the surgical tool 14 (FIG. 1), while the antenna 516 is in the deployed state. In the transit state, the antenna 516 has a length, a width, and a height, with the width being no larger than a largest dimension of an opening 540 into the chamber 513. In the deployed state, the antenna 516 has at least two transverse dimensions that are larger than the largest dimension of the opening 540, and preferably larger than a largest cross-sectional dimension of the surgical tool 14. Here, the antenna 516 is substantially circular, the sleeve 512 is cylindrical, the surgical tool is cylindrical, and the antenna has a diameter 542 that is greater than a diameter 544 of the chamber 513 and greater than a diameter of the surgical tool 14.

While in the example shown in FIGS. 5-8 the sleeve 512 and the capsule 514 are cylindrically shaped, with the outer surface 560 of the sleeve 512 having a cylindrical shape and the inner surface 562 having a cylindrical shape and defining the chamber 513, and the outer body 520 of the capsule 514 having a cylindrical shape, other shapes may be used. For example, the chamber 513 may have a rectangular shape, an octagonal shape, or other shape. Further, the shape of the outer body 520 of the capsule 514 and the shape of the inner surface 562 defining the chamber 513 need not be the same.

The antenna 516 may be biased toward the deployed state, here a planar position. For example, the conductive member 530 and/or the housing member 532 may be flexible and resilient and configured to have a substantially flat shape in the deployed state in the absence of non-natural forces (i.e., forces in addition to gravity and air pressure). Thus, the antenna 516 is forced into the transit state and will expand toward the deployed condition when no longer forced into the transit state, e.g., when removed from the sleeve 512. Forces due to interfering with the patient 10 (e.g., internal organs of the patient 10) may inhibit the antenna 516 from fully reaching the deployed state. The antenna 516 is substantially flat if the antenna 516 is flat or deflected (e.g., curved) no more than 10% of a width of the antenna or if the antenna 516 is able to receive at least 90% of the energy that the antenna 516 would receive if the antenna 516 was flat. As another example of the antenna being biased toward the deployed state, the housing member 532 may be resilient and configured to have a substantially flat shape, or at least to have a shape such that the conductive member 530 is substantially flat, in the deployed state in the absence of non-natural forces.

As shown in FIG. 8, the antenna 516 extends away from an end 550 of the capsule 514 in the deployed state. The power input 524 is disposed at the end 550 of the capsule 514, the electrical connector 518 extends away from the power input 524, and the antenna 516 extends from the electrical connector 518 further away from the end 550 of the capsule 514. This may be accomplished by having electrical connector 518 biased to extend away from the end 550, e.g., by having electrical components of the electrical connector 518 and/or the housing member 532 be resilient and configured to have a resting configuration that extends away from the end 550 (e.g., having a substantially flat resting position and physically connected to the capsule 514 extending away from the end 550).

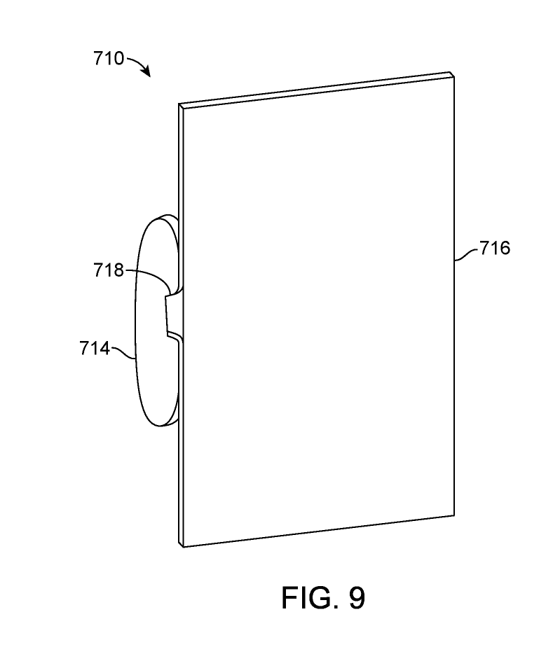

The configuration of the implant 510 is an example, and many other example configurations of implants may be used. For example, referring to FIG. 9, another example implant 710 (without a sleeve shown) includes a capsule 714, an antenna 716, and an electrical connector 718. In this example, the antenna 716 is physically connected to the capsule 714 along a length of an outer surface of an outer body of the capsule 714. The antenna 716 extends transverse to the length of the capsule 714 in the deployed state shown in FIG. 9. In the transit state (not shown), the antenna 716 is wrapped around the capsule 714 similarly to the antenna 516 and the capsule 514 shown in FIG. 5. The antenna 716 is shown generically in FIG. 9 as a rectangle, but the shape of the antenna 716 may be a rectangle or another shape and the antenna itself may be a coil or another type of antenna. If the antenna 716 is a coil, the antenna 716 may be any of a variety of appropriate types of coils, e.g., with different coils having different feed arrangements, etc.

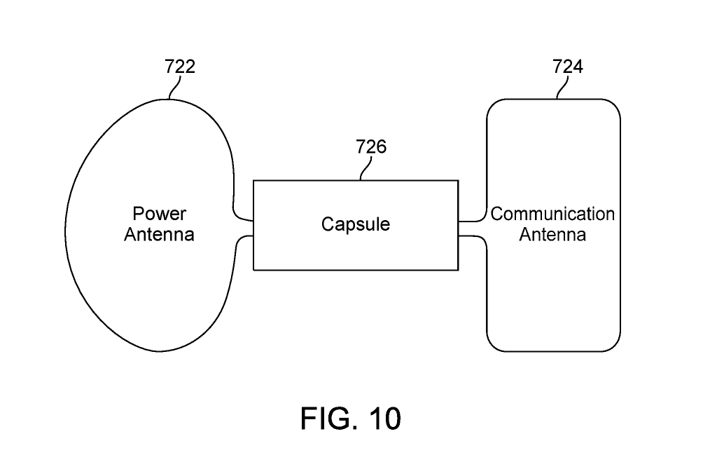

Further, more than one antenna may be provided as part of an implant. Referring to FIG. 10, two antennas 722, 724 may be connected to a capsule 726. In this example, the antennas 722, 724 extend from respective ends of the capsule 726 similarly to the antenna 516 relative to the capsule 514 shown in FIG. 8. The antenna 722 is configured to receive wireless power and to convey the power to the capsule 726, e.g., for storage in a battery. The antenna 724 is configured to receive and send communication signals, e.g., to receive commands for controlling electronics of the capsule 726 and for report information monitored by the electronics of the capsule 726. As shown, the antenna 722 is circular while the antenna is rectangular. These shapes are examples only, and many other shapes and combinations of shapes (e.g., both circular, both rectangular, etc.) may be used. In another example, both the antenna 722 and the antenna 724 are configured to receive power wirelessly. For example, when they are deployed, the antenna 722 may be in a first orientation and the antenna 724 may be in a second orientation that is different than the first orientation (e.g., the antenna 722 is in a first geometric and the second antenna 724 is in a second geometric plane that is perpendicular to the first geometric plane, or at another non-zero angle with respect to the first geometric plane). With two antennas for receiving power wirelessly, there may be a better opportunity of aligning with a transmit antenna (not shown) for increased and/or more efficient reception of power, e.g., depending on a type of transmit antenna and/or the position of the implant in the patient.

An antenna of an implant may not be biased toward the deployed state. For example, if an antenna does not include a substrate and the conductive member is flexible but does not have a default configuration, then the antenna will move only due to natural forces, e.g., gravity, or other forces such as a surgeon pushing or pulling the conductive member using a surgical tool. Thus, a capsule and antenna may be removed from (e.g., pushed through or pulled from) a sleeve and the antenna positioned as desired by a surgeon. The surgeon could position the antenna by sticking the conductive member to one or more organs of a patient, by placing the conductive member on or around a portion of the patient (e.g., an artery or vein), etc.

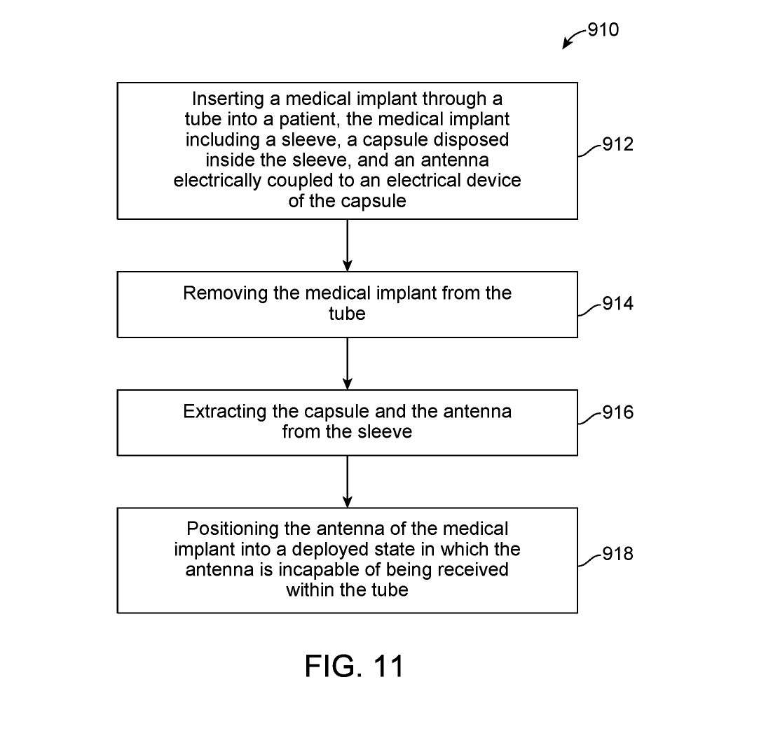

Referring to FIG. 11, with further reference to FIGS. 1-10, a method 910 of positioning an antenna inside a patient includes the stages shown. The method 910 is, however, an example only and not limiting. The method 910 can be altered, e.g., by having stages added, removed, rearranged, combined, performed concurrently, and/or having single stages split into multiple stages.

At stage 912, the method 910 includes inserting a medical implant through a tube into a patient, the medical implant including a sleeve, a capsule disposed inside the sleeve, and an antenna electrically coupled to an electrical device of the capsule. For example, the implant 510 may be pushed through the surgical tool 14 into the patient 10.

At stage 914, the method 910 includes removing the medical implant from the tube. For example, the implant 510 may be pushed and/or pulled from an end of the surgical tool 14.

At stage 916, the method 910 includes extracting the capsule and the antenna from the sleeve. For example, the capsule 514 and the antenna 516 may be pushed or pulled from the sleeve 512.

At stage 918, the method includes positioning the antenna of the medical implant into a deployed state in which the antenna is incapable of being received within the tube. The antenna may be positioned in the deployed state in numerous ways. For example, positioning the antenna may comprise removing the medical implant from a sleeve containing the implant to allow a bias of the antenna toward the deployed state to move the antenna toward the deployed state. For example, the antenna 516 (possibly along with the capsule 514 and the electrical connector 518) may be pushed and/or pulled from the sleeve 512. The resiliency of the conductive member 530 and/or the housing member 532, and the resting position being the deployed state, will cause the antenna 516 to move toward the deployed state absent external force(s) inhibiting such movement. As another example of how the antenna may be positioned in the deployed state, positioning the antenna may comprise manipulating the antenna, after extracting the antenna from the sleeve, into the deployed state. For example, if the antenna 516 is not biased toward the deployed state, then a surgeon may manually move a conductive member (or members) of the antenna 516 into the deployed state. Still other techniques may be used to position the antenna into the deployed state. In any case, in the deployed state, the antenna is incapable of being received within the tube (i.e., without being collapsed or otherwise re-positioned to fit within the tube).

The method 910 may include further stages and/or other functions may be performed beyond the method 910. For example, power may be coupled wirelessly to the antenna from outside the patient. For example, the transmitter 204 sends power via the antenna 214 to the antenna 218 (e.g., the antenna 516). This power may be used to charge the battery 236 to power the capsule 514 (e.g., a sensor and/or a processor and/or a probe (that may deliver a signal) of the capsule 514). The antenna 516 being in the deployed state may allow more energy to be coupled to the antenna than if the antenna was smaller and/or not in the deployed state. Thus, energy may be delivered further into a patient for powering an implant, allowing greater possibilities for types of implants that may be used without having to perform further surgery to replace an implant battery or otherwise power the implant.

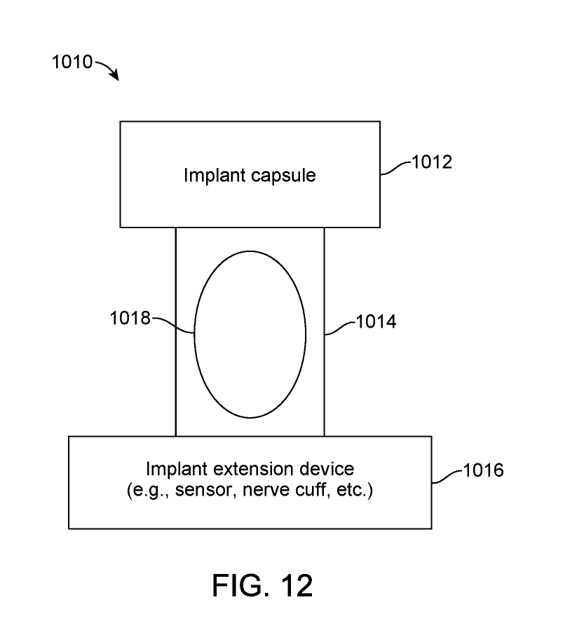

Still other configurations are possible. For example, referring to FIG. 12, an implant 1010 includes an implant capsule 1012, a harness 1014, an implant extension device 1016, and an antenna 1018. The implant capsule 1012 includes electronics for performing desired functions (e.g., processing monitored information). The implant extension device 1016 is configured to interact with the implant capsule to perform one or more desired functions, such as collecting information. For example, the implant extension device may be a sensor, a nerve cuff, etc. The implant extension device 1016 is electrically coupled to the implant capsule by the harness 1014, that includes one or more electrical connectors (e.g., electrode leads). The antenna 1018 is disposed within the harness 1014 and has an appropriate design/configuration for receiving power wirelessly and transferring received power to the implant capsule for powering or charging the implant capsule 1012 (e.g., charging a battery of the implant capsule 1012 for use in powering an electric device of the implant capsule 1012). For example, the antenna 1014 may be a loop antenna or a coil antenna, or another configuration including a combination of configurations.

Other Considerations

As used herein, “or” as used in a list of items prefaced by “at least one of” or prefaced by “one or more of” indicates a disjunctive list such that, for example, a list of “at least one of A, B, or C,” or a list of “one or more of A, B, or C” means A or B or C or AB or AC or BC or ABC (i.e., A and B and C), or combinations with more than one feature (e.g., AA, AAB, ABBC, etc.).

As used herein, unless otherwise stated, a statement that a function or operation is “based on” an item or condition means that the function or operation is based on the stated item or condition and may be based on one or more items and/or conditions in addition to the stated item or condition.

Further, an indication that information is sent or transmitted, or a statement of sending or transmitting information, “to” an entity does not require completion of the communication. Such indications or statements include situations where the information is conveyed from a sending entity but does not reach an intended recipient of the information. The intended recipient, even if not actually receiving the information, may still be referred to as a receiving entity, e.g., a receiving execution environment. Further, an entity that is configured to send or transmit information “to” an intended recipient is not required to be configured to complete the delivery of the information to the intended recipient. For example, the entity may provide the information, with an indication of the intended recipient, to another entity that is capable of forwarding the information along with an indication of the intended recipient.

Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations.

Further, more than one invention may be disclosed.

Substantial variations to described configurations may be made in accordance with specific requirements. For example, customized hardware might also be used, and/or particular elements might be implemented in hardware, software (including portable software, such as applets, etc.), or both. Further, connection to other computing devices such as network input/output devices may be employed.

Common forms of physical and/or tangible computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, EPROM, a FLASH-EPROM, any other memory chip or cartridge, a carrier wave as described hereinafter, or any other medium from which a computer can read instructions.

The processes, systems, and devices discussed above are examples, and as such are not limiting of the claims or the invention(s) as a whole. Various configurations may omit, substitute, or add various procedures or components as appropriate. For instance, in alternative configurations, the processes may be performed in an order different from that described, and that various steps may be added, omitted, or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations provides a description for implementing described techniques. Various changes may be made in the function and arrangement of elements without departing from the spirit or scope of the disclosure.

Also, configurations may be described as a process which is depicted as a flow diagram or block diagram. Although each may describe the operations as a sequential process, some operations may be performed in parallel or concurrently. In addition, the order of the operations may be rearranged. A process may have additional stages or functions not included in the figure. Furthermore, examples of the methods may be implemented by hardware, software, firmware, middleware, microcode, hardware description languages, or any combination thereof. When implemented in software, firmware, middleware, or microcode, the program code or code segments to perform the tasks may be stored in a non-transitory computer-readable medium such as a storage medium. Processors may perform one or more of the described tasks.

Components, functional or otherwise, shown in the figures and/or discussed herein as being connected or communicating with each other are communicatively coupled. That is, they may be directly or indirectly connected to enable communication between them.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of operations may be undertaken before, during, or after the above elements are considered. Accordingly, the above description does not bound the scope of the claims.

What is claimed is:

1. A biomedical system comprising:
a medical implant capsule including an outer body, an electric device retained by the outer body, and a power input coupled to the electric device, the medical implant capsule having a length, along an axis, and a width transverse to the axis; and
an antenna coupled to the power input and configured to:
receive power wirelessly and to deliver the power to the power input;
wrap around the medical implant capsule, in a transit state, transverse to the length of the medical implant capsule for a distance greater than the width of the medical implant capsule; and
expand to a deployed state, at least part of the antenna being further from the axis in the deployed state than in the transit state.

2. The biomedical system of claim 1, wherein the antenna is configured to unwrap from the medical implant capsule to expand to the deployed state.

3. The biomedical system of claim 1, wherein the antenna comprises a coil disposed in a biologically compatible housing sheet, the antenna is biased to be planar, and wherein to wrap around the medical implant capsule the antenna is configured to form a tube.

4. The biomedical system of claim 1, wherein the antenna is configured to wrap around the medical implant capsule transverse to the length of the medical implant capsule for a distance, the distance being greater than a perimeter of the medical implant capsule transverse to the axis.

5. The biomedical system of claim 4, wherein the distance is greater than 150% of the perimeter of the medical implant capsule transverse to the axis.

6. The biomedical system of claim 1, wherein the antenna is biased toward the deployed state.

7. The biomedical system of claim 1, wherein the antenna is configured to extend away from an end of the medical implant capsule when in the deployed state.

8. The biomedical system of claim 1, wherein the antenna is physically connected to the medical implant capsule along a length of an outer surface of the outer body.

9. The biomedical system of claim 1, further comprising a container defining a chamber configured to receive the medical implant capsule and the antenna, the chamber having a chamber width transverse to a chamber length, the antenna being further configured to be:
disposed between the container and the medical implant capsule with the medical implant capsule and the antenna received by the container and the antenna in the transit state; and
wrapped around the medical implant capsule for a distance longer than the chamber width.

10. The biomedical system of claim 9, wherein the antenna is biased toward the deployed state, and wherein the antenna is incapable of being received by the container when in the deployed state.

11. The biomedical system of claim 1, wherein the length of the medical implant capsule is greater than the width of the medical implant capsule.

12. The biomedical system of claim 1, wherein the antenna is a first antenna, the biomedical system further comprising a second antenna configured to transmit and receive communication signals.

13. A biomedical system comprising:
a sleeve defining a chamber having a chamber width that is transverse to a chamber length that is parallel to an axis of the sleeve, the chamber length being longer than the chamber width; and
an antenna with an antenna length and an antenna width, the antenna length and the antenna width each being larger than the chamber width, the antenna including a flexible coil and being configured to:
receive power wirelessly;
bend about the length of the antenna to be received by the chamber in a transit state; and
expand to a deployed state outside of the sleeve such that the flexible coil antenna is incapable of being received by the sleeve while in the deployed state.

14. The biomedical system of claim 13, wherein the antenna includes a resilient conductive member that is biased toward the deployed state.

15. The biomedical system of claim 13, wherein the antenna includes a biologically-compatible substrate and a conductive member, and wherein the conductive member is isolated by the biologically-compatible substrate from physical contact with an entity outside of the biologically-compatible substrate.

16. The biomedical system of claim 15, wherein the biologically-compatible substrate is sufficiently resilient to bias the antenna toward the deployed state.

17. The biomedical system of claim 15, wherein the biologically-compatible substrate is a biologically-inert substrate.

18. The biomedical system of claim 13, further comprising a medical implant capsule including a cylindrical outer body, an electric device retained by the body, and a power input electrically coupled to the electric device, the medical implant capsule being shaped and sized to be received by the chamber defined by the sleeve, wherein the antenna is electrically coupled to the power input and is configured to be:
disposed between the sleeve and the medical implant capsule with the medical implant capsule and the antenna received by the sleeve and the antenna in the transit state; and
wrapped around the medical implant capsule for a distance longer than the chamber width.

19. The biomedical system of claim 13, wherein the antenna is a first antenna, the biomedical system further comprising a second antenna configured to transmit and receive communication signals.

20. A method of providing positioning, and deploying an antenna of, a medical implant inside a patient, the method comprising:
inserting the medical implant through a tube into the patient, the medical implant including a sleeve, a capsule disposed inside the sleeve, and an antenna electrically coupled to an electrical device of the capsule;
removing the medical implant from the tube;
extracting the capsule and the antenna from the sleeve; and
positioning the antenna of the medical implant into a deployed state in which the antenna is incapable of being received within the tube.

21. The method of claim 20, wherein positioning the antenna comprises allowing a bias of the antenna toward the deployed state to move the antenna toward the deployed state.

22. The method of claim 20, wherein positioning the antenna comprises manipulating the antenna, after extracting the antenna from the sleeve, into the deployed state.

23. A biomedical system comprising:
a sleeve defining a cylindrical chamber having a chamber diameter that is transverse to a chamber length that is parallel to an axis of the sleeve, the chamber length being longer than the chamber diameter;
a medical implant capsule including:
a cylindrical outer body that is biologically compatible and of a capsule length;
an electric device retained by the cylindrical outer body; and
a power input electrically coupled to the electric device; and
an antenna coupled to the power input and configured to:
receive power wirelessly and to deliver received power to the power input;
wrap around the cylindrical outer body of the medical implant capsule transverse to the capsule length for a distance greater than the chamber diameter; and
expand from a transit state to a deployed state, the antenna being biased toward the deployed state.

24. The biomedical system of claim 23, wherein the antenna further comprises a biologically compatible housing sheet encapsulating a planar coil.

25. The biomedical system of claim 23, wherein the antenna is configured to wrap around the medical implant capsule transverse to the capsule length of the medical implant capsule for a distance, the distance being greater than a circumference of the cylindrical outer body.

26. The biomedical system of claim 25, wherein the distance is greater than 150% of the circumference of the cylindrical outer body.
